(19) United States
(12) Patent Application Publication
(10) Pub. No.: US 2026/0343489 A1
(43) Pub. Date: Oct. 29, 2026

(54) PREDICTION APPARATUS, PREDICTION SYSTEM, PREDICTION METHOD, AND PROGRAM

(71) Applicant: NTT, Inc., Tokyo (JP)

(72) Inventors: Naoki SHIBUYA, Tokyo (JP); Kenichi KAWAMURA, Tokyo (JP); Motoharu SASAKI, Tokyo (JP); Takatsune MORIYAMA, Tokyo (JP)

(73) Assignee: NTT, Inc., Tokyo (JP)

(21) Appl. No.: 19/119,710

(22) PCT Filed: Oct. 26, 2022
(86) PCT No.: PCT/JP2022/039991

§ 371 Date: Apr. 9, 2025

(51) Int. Cl. H04W 64/00; H04B 17/373

(52) U.S. Cl. CPC H04W 64/006; H04B 17/373

(57) ABSTRACT

A prediction apparatus includes: a future position information calculation unit that acquires a speed of a target terminal and calculates a range of a certain shape as an estimated movement range of the target terminal within a predetermined time period based on the speed, and a prediction value calculation unit that calculates a prediction value of communication quality of the target terminal based on communication qualities at a plurality of positions within the range of the shape.

### TECHNICAL FIELD

The present invention relates to a technique for predicting radio communication quality.

### BACKGROUND ART

In applications of remote control, remote monitoring and the like of a mobile object such as a vehicle or a robot, generally remote communication is carried out between a server of a center and a terminal provided in the mobile object at a site by radio communication. In addition, since the mobile object moves, radio communication quality of remote communication is required to be of high availability in consideration of safety. It is considered that it is effective to estimate (predict) whether radio communication quality can be stably used at a destination of a mobile object, and to perform processing such as switching lines in advance or lowering a rate of video transmission so as not to cause instantaneous interruption of video when there is a risk. Therefore, it is important to estimate the communication quality at the destination.

As a technique for predicting radio communication quality at the destination, there is a technique disclosed in, for example, NPL 1. According to the technique disclosed in NPL 1, a model for calculating a prediction value of radio communication quality of the position of the terminal is trained from past quality information by means of machine learning. By using this model, radio communication quality at the future position of the terminal can be predicted.

### CITATION LIST

### Non Patent Literature

NPL 1: Naoki Shibuya, et al. “A study on prediction of radio communication quality using machine learning,” IEICE General Conference, B-6-74, March 2022.

### SUMMARY OF INVENTION

### Technical Problem

In the related art, the prediction of the future position has been performed on the assumption that the terminal moves at a constant speed and linearly until the terminal reaches the future position. However, actual terminals (e.g., AGV, vehicle, automatic driving agricultural machine, etc.) may change their speeds (speeds and traveling directions) depending on the situation.

Therefore, in the related art, since a deviation occurs between an actual future position of the terminal and the predicted future position, a deviation occurs between the radio communication quality at the actual future position of the terminal and a prediction value of the radio communication quality at the predicted future position.

The present invention was made in view of the foregoing points, and an object of the present invention is to provide a technique for predicting communication quality at a future position of a terminal, the technique being more accurate than that of related art.

### Solution to Problem

According to the disclosed technique, provided is a prediction apparatus, including: a future position information calculation unit that acquires a speed of a target terminal and calculates a range of a certain shape as an estimated movement range of the target terminal within a predetermined time period based on the speed; and
a prediction value calculation unit that calculates a prediction value of communication quality of the target terminal based on communication qualities of a plurality of positions within the range of the shape.

### Advantageous Effects of Invention

According to the disclosed technique, there is provided a technique for predicting communication quality at a future position of a terminal more accurately than in the related art.

### BRIEF DESCRIPTION OF DRAWINGS

FIG. 1 is a diagram for explaining a problem.

FIG. 2 is a diagram illustrating a problem.

FIG. 3 is a diagram showing a configuration example of a prediction apparatus 100.

FIG. 4 is a flowchart for explaining operations according to Example 1.

FIG. 5 is a diagram showing an example of a fan-shaped range.

FIG. 6 is a diagram showing an example of a sampling.

FIG. 7 is a diagram for explaining an example of statistical processing.

FIG. 8 is a flowchart for explaining operations according to Example 2.

FIG. 9 is a diagram showing an image of calculation of a future position.

FIG. 10 is a diagram showing a hardware configuration example of the prediction apparatus 100.

### DESCRIPTION OF EMBODIMENTS

Hereinafter, an embodiment of the present invention (the present embodiment) will be described with reference to the drawings. The embodiment to be described below is merely an example, and an embodiment to which the present invention is applied is not limited to the following embodiment.

In the following description, it is assumed that “communication quality” refers to the quality of radio communication, but the technique according to the present invention is applicable to communication quality of wired communication instead of wireless communication. For example, the technique according to the present invention can be applied in an environment in which devices in which a terminal can be connected to a network by a wired connection are installed at various places (positions).

In the following description, it is assumed that the communication quality refers to the quality of the communication when a terminal performs the radio communication, unless otherwise specified. Further, the “communication quality” may be referred to as “quality.”

It is assumed that the “terminal” moves. The “terminal” may be a smart phone or the like owned by a person, or a communication device mounted on a mobile object such as a drone, an automobile, or a robot, and a mobile object itself such as a drone, an automobile, or a robot\may be referred to as a “terminal.”

The “communication quality” used in the following may refer to any of reception power, throughput, delay, jitter, and packet loss, or the “communication quality” may refer to other quality.

### Regarding Problems

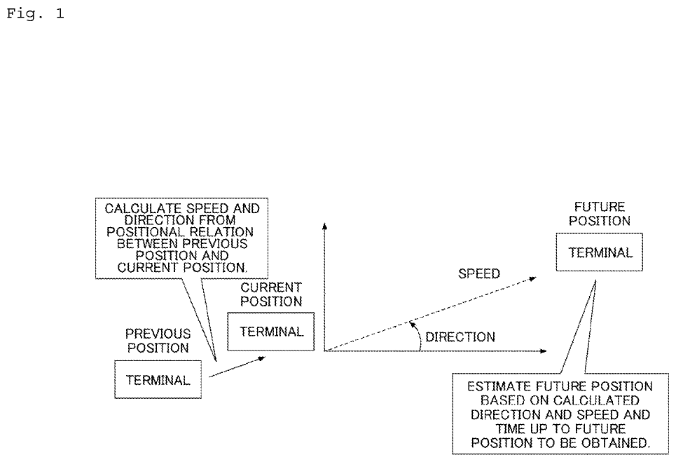

First, problems in the present embodiment will be described. In the related art, as shown in FIG. 1, the future position of the terminal is predicted on the assumption that the terminal moves at a constant speed and linearly until the terminal reaches the future position, and the communication quality is predicted using the predicted future position.

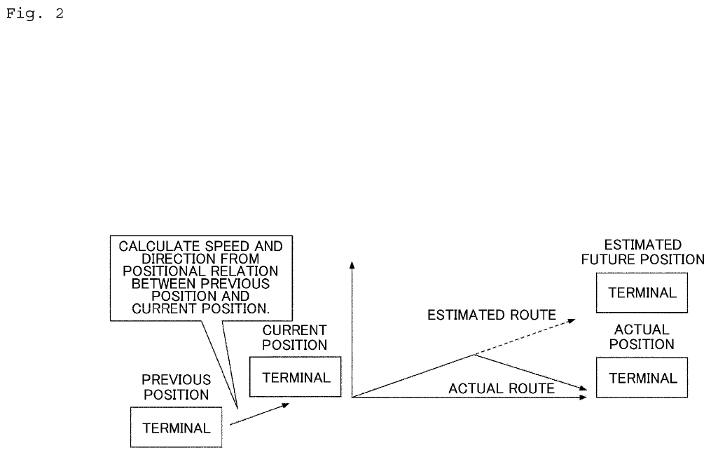

However, the actual terminal changes its speed according to the situation. Therefore, as shown in FIG. 2, for example, a deviation occurs between the estimated future position of the terminal and the position of the terminal to be executed. Therefore, a deviation occurs also between the actual communication quality of the terminal and the predicted communication quality at the predicted future position.

Therefore, in the present embodiment, a technique for estimating the future position with high accuracy even when the speed of the moving terminal changes will be described.

### Device Configuration

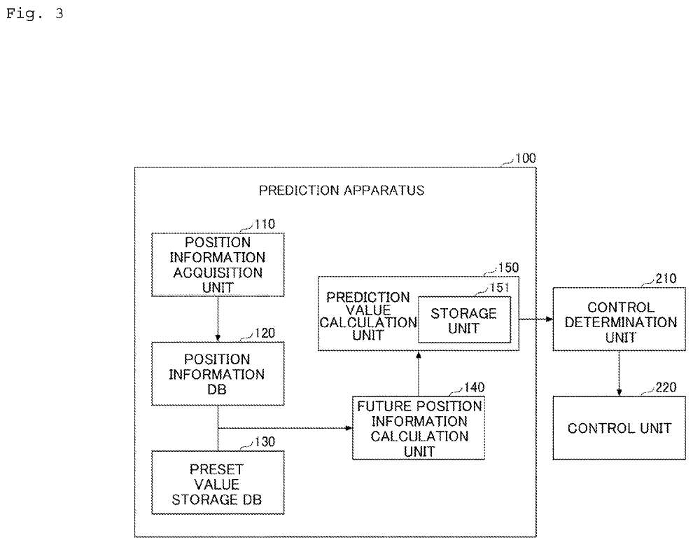

FIG. 3 shows a configuration example of a prediction apparatus 100 according to the present embodiment. As shown in FIG. 3, the prediction apparatus 100 includes a position information acquisition unit 110, a position information DB (database) 120, a preset value storage DB 130, a future position information calculation unit 140, and a prediction value calculation unit 150.

FIG. 3 also shows a control determination unit 210 and a control unit 220. In the example shown in FIG. 3, it is assumed that the control determination unit 210 and the control unit 220 are provided inside a terminal (referred to as a target terminal), which is a target of communication quality prediction. However, the control determination unit 210 and the control unit 220 may be provided outside the target terminal.

The prediction apparatus 100 (the position information acquisition unit 110, the position information DB 120, the preset value storage DB 130, the future position information calculation unit 140, and the prediction value calculation unit 150) may be provided inside the target terminal or outside the target terminal.

When the configuration of the prediction apparatus 100 shown in FIG. 3 is provided inside the terminal, the terminal may be referred to as a prediction apparatus.

Also, the prediction value calculation unit 150 of the prediction apparatus 100 may be provided in a server outside the prediction apparatus 100. For example, “position information acquisition unit 110, position information DB 120, preset value storage DB 130, future position information calculation unit 140, control determination unit 210, control unit 220” shown in FIG. 3 may be provided inside the target terminal, and the prediction value calculation unit 150 may be provided in an external server.

When the prediction apparatus 100 (position information acquisition unit 110, position information DB 120, preset value storage DB 130, future position information calculation unit 140) is present in a terminal and the prediction value calculation unit 150 is present in a server, a system having the prediction apparatus 100 (terminal) and the server may be referred to as a prediction system.

The prediction value calculation unit 150 has a function of calculating a prediction value of communication quality at the position of the target terminal based on the position information of the target terminal. The prediction value can be acquired (calculated) only from the position information, or can be acquired (calculated) by using reception power information of the position, point group information acquired by a LiDAR at the position, or the like.

### Operation Example of Prediction Apparatus 100: Example 1

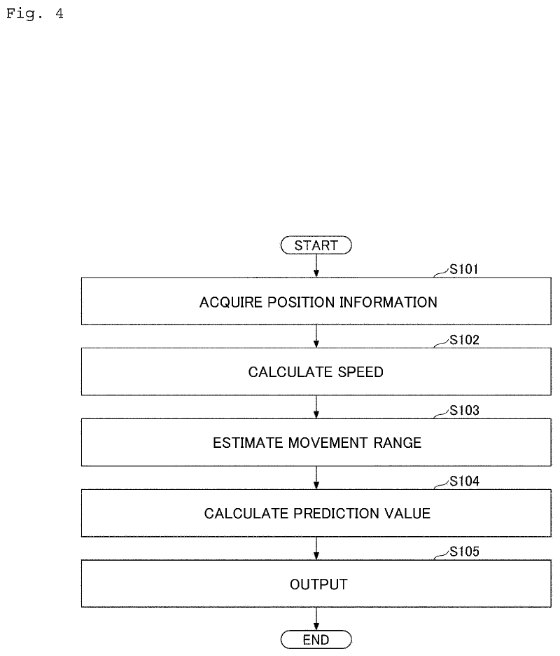

An operation example of the prediction apparatus 100 with the configuration shown in FIG. 3 according to Example 1 will be described with reference to a flowchart shown in FIG. 4. Note that a preset value used for calculation (T_{dir} described later, how many seconds ahead the prediction is made, etc.) is stored in the preset value storage DB 130.

### <S101>

In S101, the position information acquisition unit 110 acquires position information indicating the current position of the target terminal. The position information acquisition unit 110 stores the acquired position information in the position information DB 120 together with a measurement time.

In a case where the position information acquisition unit 110 is provided inside the target terminal, the position information acquisition unit 110 is, for example, a GNSS receiver, and S101 corresponds to acquiring position information by the GNSS (GPS or the like).

When the position information acquisition unit 110 is provided outside the target terminal, S101 corresponds to receiving, for example, a positioning result (position information) obtained by the GNSS by the target terminal from the target terminal.

### <S102>

In S102, the future position information calculation unit 140 acquires the position information of the target terminal at the time of previous measurement thereof, from the position information DB 120, and calculates the magnitude of a speed vₜ (e.g., m/s) of the target terminal, from the position information and the current position information. Note that the “speed” is a vector having a magnitude and a direction.

For the traveling direction at the speed, the future position information calculation unit 140 reads the position information of the target terminal in the past T_{dir} seconds from the position information DB 120, and calculates the traveling direction of the target terminal from the position information by means of least mean square approximation or the like.

For example, when the speed vₜ can be acquired from a sensor or the like of the target terminal, the future position information calculation unit 140 may use the speed vₜ.

### <S103>

In S103, the future position information calculation unit 140 calculates a fan-shaped range determined from a travel distance within a predetermined time period (e.g., the number of seconds) within a range of a predetermined ±θ angle (the unit is degree, for example) from the traveling direction calculated in S102, and estimates that the range is a movement range of the target terminal.

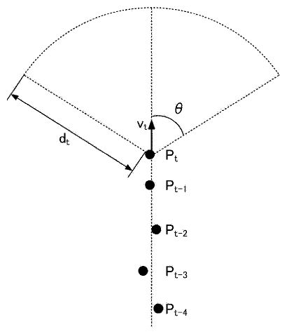

FIG. 5 shows an image of the fan-shaped range calculated in S103. In FIG. 5, Pₜ is the position of the target terminal at the current time t (the position measured at the most recent time t), and is at the center of the fan shape. vₜ (vector) is the speed calculated in S102. The radius dₜ of the fan shape is calculated by dₜ=|vₜ|×T_{pred} by using the magnitude of the speed, |vₜ|, and the predetermined time period (the unit is seconds, for example) T_{pred}. As shown in FIG. 5, this fan shape is a fan shape having an angle of ±θ with the traveling direction as the center axis.

The future position information calculation unit 140 transfers information indicating the fan-shaped range (e.g., FIG. 5) to the prediction value calculation unit 150.

By adopting the fan-shaped range as described above, it is possible to cope with a terminal movement pattern obtained other than when the terminal moves at a constant speed and linearly. It is to be noted that shaping the estimated movement range of the target terminal into a fan shape is an example. The range of the shape other than the fan shape may be used as the estimated movement range of the target terminal.

### <S104 and S105>

It is assumed that the prediction value calculation unit 150 holds, for example, the communication quality of each point (each position) in the storage unit 151 such as a memory included in the prediction value calculation unit 150. The communication quality may be an estimated value (prediction value), a past actual value, or a statistical value calculated from the past actual value.

The prediction value calculation unit 150 refers to the storage unit 151 to acquire communication quality at a sampled position within the fan-shaped range calculated in S103, and performs statistical processing on the acquired communication quality. The prediction value calculation unit 150 sets a result of the statistical processing as a prediction value of communication quality at a designated second ahead in the target terminal. The “designated second ahead” means, for example, a time ahead of the current time t by T_{pred}.

In S105, the prediction value calculation unit 150 outputs the prediction value. The prediction value is input to the control determination unit 210. Once understanding that, for example, the quality of the current line is deteriorated by the prediction value, the control determination unit 210 determines that line switching is necessary, and instructs the control unit 220 to switch the line. The control unit 220 executes control for switching a line used by the target terminal.

### <Sampling>

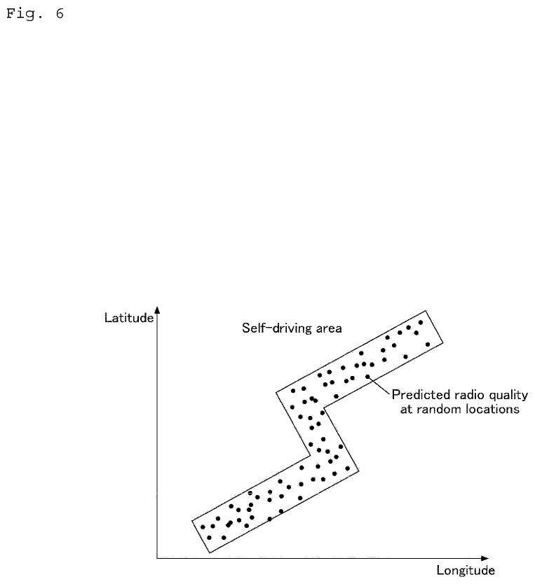

An example of the sampling processing described above will now be described. In the sampling processing, the prediction value calculation unit 150 randomly selects, for example, a plurality of points within the fan-shaped range in a range within a traveling area set beforehand, and acquires communication quality of the points. An image of this processing is shown in FIG. 6. In particular, when there is no area such as the traveling area, the prediction value calculation unit 150 may acquire communication qualities of all the points within the fan-shaped range.

### <Statistical Processing>

As the statistical processing described above, the prediction value calculation unit 150 performs any of the following processes (1) to (4), for example. Note that (1) to (4) are examples; thus statistical processing other than (1) to (4) may be performed. Any two or more of the (1) to (4) may be combined.
(1) The prediction value calculation unit 150 adopts the average value of all the acquired communication qualities as a prediction value.
(2) The prediction value calculation unit 150 adopts a value of the lowest quality among the acquired communication qualities as a prediction value.
(3) The future position information calculation unit 150 obtains a correlation between a magnitude |vₜ| of the speed of the target terminal and an angle θ (=angle θ for determining the fan-shaped range) at which the target terminal turns, from a movement record (or a preset value) of the target terminal, and determines θ corresponding to the magnitude |vₜ| of the speed of the target terminal based on the correlation. It is assumed that the greater the |vₜ|, the smaller the θ.

The future position information calculation unit 150 notifies the prediction value calculation unit 150 of the information of the fan-shaped range in which the θ determined by the foregoing method and the above-described dₜ are used.

The prediction value calculation unit 150 adopts the prediction value calculated by the already-described method (average value, etc.) from the fan-shaped range. The process (3) may be entirely performed by the prediction value calculation unit 150.
(4) The prediction value calculation unit 150 weights the communication qualities acquired from the fan-shaped range according to the traveling distance by using the magnitude |vₜ| of the speed, and calculates a prediction value by using the weighted average. For example, the acquired communication qualities are defined as x1, x2, . . . , xN, and when weights corresponding to these communication qualities are represented by w1, w2, . . . , wN, the weighted average is calculated by “(w1×1+ . . . +wN×N)/(w1+ . . . +wN).”

As for the weights, for example, a correlation between the magnitude |vₜ| of the speed and a position within the fan-shaped range (e.g., a distance from the center of the fan shape) is obtained in advance, and the weights are increased as the correlation becomes large. As for the method of obtaining the correlation, for example, a movement record can be used.

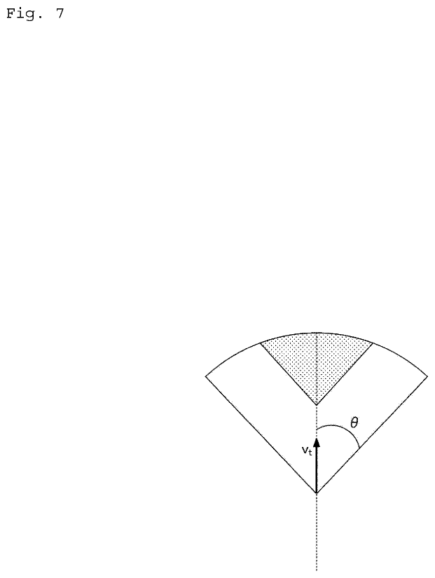

For example, it is assumed that as the |vₜ| becomes large, the weight of the position where the distance from the center of the fan shape is long becomes larger than the weight of the position where the distance from the center of the fan shape is short. An image of such correlation (weight) is shown in FIG. 7. The larger the |vₜ|, the higher the probability that the future position falls within the shaded range, so that the weight to the communication quality within the shaded range is increased and the weight to the communication quality outside the shaded range is decreased.

### Operation Example of Prediction Apparatus 100: Example 2

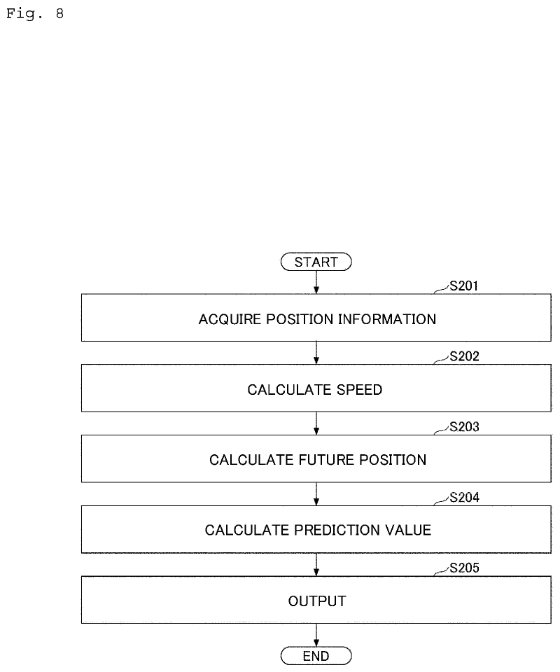

As processing that is performed when the fan-shaped range designation is not used as in the above-described Example 1, an example of processing performed when a movement route (e.g., a traveling route of an automobile) is uniquely determined will be described as Example 2. An operation example of the prediction apparatus 100 according to Example 2 will be described with reference to the flowchart of FIG. 8. Note that a preset value used for calculation (how many seconds ahead the prediction is made, etc.) is stored in the preset value storage DB 130. Further the movement route of the target terminal is stored in the preset value storage DB 130.

### <S201>

S201 is the same as S101 of Example 1. In S201, the position information acquisition unit 110 acquires position information indicating the current position of the target terminal. The position information acquisition unit 110 stores the acquired position information in the position information DB 120 together with a measurement time.

### <S202>

S202 is the same as S102 of Example 1. In S202, the future position information calculation unit 140 calculates (or acquires) the speed vₜ of the target terminal.

### <S203>

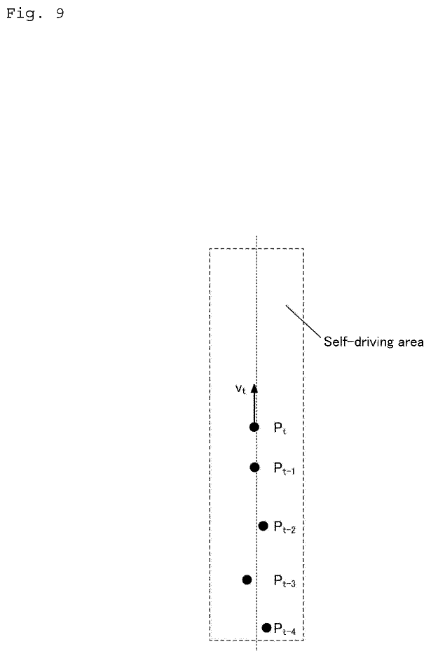

In S203, the future position information calculation unit 140 calculates a future position P of the target terminal by P=|vₜ|×T_{pred} using the speed vₜ and the time it takes to the future position (e.g., the number of seconds) T_{pred}, along the movement route. Here, it is assumed that the movement route is a straight line at least during the period of T_{pred}. Alternatively, even when the automobile is moving at a high speed, T_{pred} may be set as the time when the movement route can be assumed to be a straight line. An image of the calculation of P is shown in FIG. 9.

In S202 and S203, when the future position information calculation unit 140 detects that the calculated P or past location is a value deviated from the movement route due to positioning errors or the like, the value is corrected to the value of the nearest point on the movement route.

The future position information calculation unit 140 transfers information indicating the future position P to the prediction value calculation unit 150.

### <S204 and S205>

It is presumed that the prediction value calculation unit 150 holds the communication quality of each point (each position) in the storage unit 151 such as a memory included in the prediction value calculation unit 150. The communication quality may be an estimated value (prediction value) or a past actual value.

The prediction value calculation unit 150 refers to the storage unit 151 to acquire the communication quality at the future position P calculated in S203, and sets this acquired communication quality as the prediction value of the communication quality at the time ahead from the current time t by T_{pred} in the target terminal. S205 is the same as S105 of Example 1.

### Hardware Configuration Example

The prediction apparatus 100 described in the present embodiment can be realized by, for example, causing a computer to execute a program. This computer may be a physical computer or a virtual machine on the cloud.

That is, the prediction apparatus 100 can be realized by executing a program corresponding to processing performed by the prediction apparatus 100 by using hardware resources such as a CPU and a memory built in the computer. The program described above can be recorded on a computer-readable recording medium (such as a portable memory) and can be stored or distributed. Further, the program described above can also be provided through a network such as the Internet or e-mail.

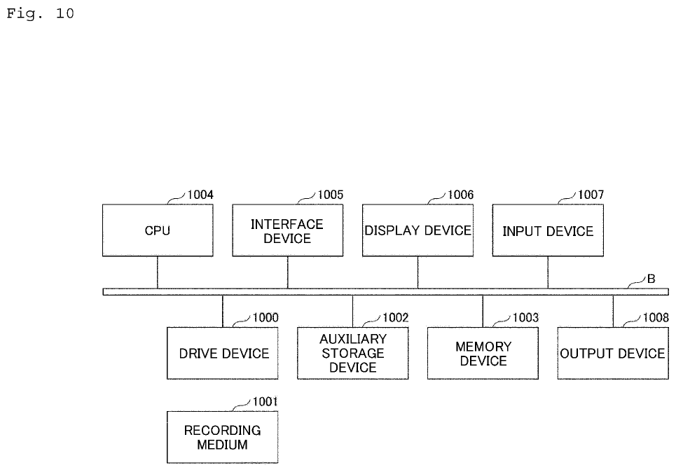

FIG. 10 is a diagram showing an example of a hardware configuration of the computer described above. The computer shown in FIG. 7 includes a drive device 1000, an auxiliary storage device 1002, a memory device 1003, a CPU 1004, an interface device 1005, a display device 1006, an input device 1007, and an output device 1008, which are connected to each other via a bus BS. The computer may further include a GPU.

A program for realizing processing in the computer is provided by, for example, a recording medium 1001 such as a CD-ROM or a memory card. When the recording medium 1001 having the program stored therein is set in the drive device 1000, the program is installed in the auxiliary storage device 1002 from the recording medium 1001 via the drive device 1000. However, the program does not necessarily have to be installed from the recording medium 1001, and may be downloaded from another computer via a network. The auxiliary storage device 1002 stores the installed program and also stores necessary files, data, and the like.

The memory device 1003 reads and stores the program from the auxiliary storage device 1002 when there is an instruction to start the program. The CPU 1004 realizes functions related to the prediction apparatus 100 according to a program stored in the memory device 1003. The interface device 1005 is used as an interface for connection to a network. The display device 1006 displays a Graphical User Interface (GUI) or the like according to a program. The input device 1007 is configured of a keyboard, a mouse, buttons, a touch panel, or the like, and is used to input various operation instructions. The output device 1008 outputs a calculation result.

### Effects of Embodiment

In the technique for predicting the communication quality at a future position of a terminal, according to the technique described in the present embodiment, the communication quality can be predicted more accurately than in the related art.

Regarding the foregoing embodiment, the following additional notes are further disclosed.

### Additional Notes

(Clause 1)

A prediction apparatus, including:
a memory; and
at least one processor connected to the memory,
wherein
the processor
acquires a speed of a target terminal and calculates a range of a certain shape as an estimated movement range of the target terminal within a predetermined time period based on the speed, and
calculates a prediction value of communication quality of the target terminal based on communication qualities of a plurality of positions within the range of the shape.
(Clause 2)

The prediction apparatus according to clause 1, wherein the shape is a fan shape having an angle of ±θ with a traveling direction of the target terminal as a center axis, and having a moving distance at the speed for the predetermined time period as a radius.
(Clause 3)

The prediction apparatus according to clause 1 or 2, wherein the processor calculates, as the prediction value, a value obtained by calculating a weighted average by using a weight corresponding to a position with respect to the communication qualities of the plurality of positions.
(Clause 4)

A prediction apparatus, including:
a memory; and
at least one processor connected to the memory,
wherein
the processor
acquires a speed of a target terminal and calculates a future position of the target terminal on a predetermined movement route based on the speed, and
calculates a prediction value of communication quality of the target terminal at the future position.
(Clause 5)

A prediction system, including:
a future position information calculation unit that acquires a speed of a target terminal and determines a range of a certain shape as an estimated movement range of the target terminal within a predetermined time period based on the speed; and
a prediction value calculation unit that calculates a prediction value of communication quality of the target terminal based on communication qualities of a plurality of positions within the range of the shape.
(Clause 6)

A prediction method that is executed by a prediction apparatus, including steps of:
acquiring a speed of a target terminal and calculating a range of a certain shape as an estimated movement range of the target terminal within a predetermined time period based on the speed; and
calculating a prediction value of communication quality of the target terminal based on communication qualities of a plurality of positions within the range of the shape.
(Clause 7)

A prediction method that is executed by a prediction apparatus, including steps of:
acquiring a speed of a target terminal and calculating a future position of the target terminal on a predetermined movement route based on the speed; and
calculating a prediction value of communication quality of the target terminal at the future position.
(Clause 8)

A non-transitory recording medium that stores a program for causing a computer to function as each unit of the prediction apparatus according to any one of clauses 1 to 4.

Although the present embodiment has been described above, the present invention is not limited to such a specific embodiment, and various modifications and changes can be made within the scope of the present invention described in the claims.

### REFERENCE SIGNS LIST

100 Prediction apparatus
110 Position information acquisition unit
120 Position information DB
130 Preset value storage DB
140 Future position information calculation unit
150 Future value calculation unit
151 Storage unit
210 Control determination unit
220 Control unit
1000 Drive device
1001 Recording medium
1002 Auxiliary storage device
1003 Memory device
1004 CPU
1005 Interface device
1006 Display device
1007 Input device
1008 Output device

1. A prediction apparatus, comprising:
a memory; and
a processor coupled to the memory and configured to:
acquire a speed of a target terminal and calculate a range of a certain shape as an estimated movement range of the target terminal within a predetermined time period based on the speed; and
calculate a prediction value of communication quality of the target terminal based on communication qualities of a plurality of positions within the range of the shape.

2. The prediction apparatus according to claim 1, wherein the shape is a fan shape having an angle of ±θ with a traveling direction of the target terminal as a center axis, and having a moving distance at the speed for the predetermined time period as a radius.

3. The prediction apparatus according to claim 1, wherein the processor is configured to calculate, as the prediction value, a value obtained by calculating a weighted average by using a weight corresponding to a position with respect to the communication qualities of the plurality of positions.

4. A prediction apparatus, comprising:
a memory; and
a processor coupled to the memory and configured to:
acquire a speed of a target terminal and calculate a future position of the target terminal on a predetermined movement route based on the speed; and
calculate a prediction value of communication quality of the target terminal at the future position.

5. (canceled)

6. A prediction method that is executed by a prediction apparatus, comprising steps of:
acquiring a speed of a target terminal and calculating a range of a certain shape as an estimated movement range of the target terminal within a predetermined time period based on the speed; and
calculating a prediction value of communication quality of the target terminal based on communication qualities of a plurality of positions within the range of the shape.

7. (canceled)

8. A non-transitory computer-readable recording medium storing a program for causing a computer to perform the method of claim 6.
